(19) United States
(12) Patent Application Publication
(10) Pub. No.: US 2004/0203258 A1
(43) Pub. Date: Oct. 14, 2004

(54) Connecting device for contacting electric machines

(76) Inventors: Steffen Lindoerfer, Schrozberg (DE); Thomas Botzenhard, Vaihingen/Enz (DE)

Correspondence Address: Striker Striker & Stenby, 103 East Neck Road, Huntington, NY, 11743, US

(21) Appl. No.: 10/470,428

(22) PCT Filed: Dec. 7, 2002
(86) PCT No.: PCT/DE02/04494

(30) Foreign Application Priority Data
Mar. 14, 2002 (DE) 102 11 154.5

(51) Int. Cl. H02K 11/00; H01R 41/00; H01R 39/00

(52) U.S. Cl. 439/2; 310/71

(57) ABSTRACT

The invention proposes a connecting device for contacting electric machines (13), having a first electrically insulating part (16) and a second electrically insulating part (19), wherein a retainer (22) is held between the two insulating parts (16) and (19). A conductor part (25) is separate from the retainer (22) and is connected to the second insulating part (19). The connecting device is characterized in that the first electrically insulating part (16), the retainer (22), the second electrically insulating part (19), and the conductor part (25) are non-detachably connected to one another.

### PRIOR ART

The invention relates to a connecting device for contacting electric machines as generically defined by the independent claim. A connecting device of this kind is known from the German patent application with the serial number 101 03 008.8. The connecting device for a starter described there has a first insulating part on the outside of a starter housing. This first insulating part and a second insulating part, referred to there as a spacer sleeve, hold the wall of the starter housing between them. A contacting sleeve is inserted into the first insulating part from the outside. This contacting sleeve reaches through the second insulating part and presses with a shoulder against a conductor part. A retaining nut is fastened to the conductor part. Contacts or current-carrying stranded conductors for a brush apparatus need to be fastened to the conductor part. In order to fasten the connecting device, it is necessary to insert a threaded bolt through central openings of the contact sleeve, the first insulating part, and the second insulating part and then screw it into the retaining nut on the conductor part. This design has the disadvantage of requiring a relatively large number of parts in order to produce the connecting clamp. A further disadvantage is that the threaded bolt is absolutely required in order to reliably secure the connecting clamp to the starter motor housing. In the subsequent assembly process at the motor vehicle manufacturer, it is also necessary to reloosen or completely remove the threaded bolt in order to fasten a pole clamp of a starter cable connected to the starter battery.

### ADVANTAGES OF THE INVENTION

The connecting device for contacting electric machines with the features of the main claim has the advantage that no torsional forces act on the conductor part, which precludes an undesired twisting of the printed circuit board on a ground contact.

In addition, after assembly, the bolt unit is non-detachably installed and cannot come loose by itself due to vibration during transport or even during operation. The bolt cannot get lost.

Furthermore, manipulations of the connecting device are easy to detect and require fewer components.

Advantageous modifications of the connecting device according to the main claim are possible by means of the measures taken in the dependent claims.

Since the first electrically insulating part has a ring formed onto it in one piece, oriented toward the second insulating part, and since this ring has a non-circular outer contour and a non-circular inner contour, this makes it possible to prevent the first insulating part from twisting in an opening that is adapted to the non-circular outer contour of the one-piece, formed-on ring. In this case, a positive engagement is produced so that this insulating part cannot twist when a starter cable is being fastened. At the same time, the non-circular inner contour makes it possible to assure that for example the bolt is also disposed in an unambiguous position in relation to the insulating part and therefore also in relation to the retainer. This is of particular importance when the bolt is embodied as a non-circular cylinder and therefore an unambiguous position of the bolt in relation to the retainer is required.

If the conductor part has a non-circular inner contour, then the position of the conductor part in relation to the retainer can be unambiguously determined by means of the outer contour of the bolt. It is thus possible to hold the conductor part in an unambiguous position during the fastening procedure, which is particularly advantageous when electrically conductive or ground-carrying components are located close to the conductor part, thus allowing short circuits to be prevented.

If the second electrically insulating part has a positive engagement element that points away from the first insulating part, this positive engagement element can be used to assure a reliable and unambiguous position of the insulating part in relation to the conductor part in that the conductor part has an opening that corresponds to the positive engagement element and the two positive engagement elements engage with each other.

The invention also provides for embodying the bolt with an at least two-part shaft, a first shaft part extending through the first insulating part, the retainer, the second insulating part, and the conductor part, and a second shaft part that is shaped into an annular bolt head serves to secure or connect the above mentioned parts.

If a third shaft part adjoins either the bolt or the second shaft part that is shaped into an annular bolt head, then this third shaft part permits a shaping force to be introduced, i.e. the force required to shape the second shaft part into a bolt head. In this manner, a simple positive engagement can be produced between the bolt and the tool for shaping the second shaft part; at the same time, the shaping can be executed from the end of the bolt oriented away from the third shaft part.

If the third shaft part has an internal threading, then this threading can be used to introduce a shaping force from the end of the bolt head. The force is introduced uniformly, which results in the second shaft part being formed into a uniformly shaped bolt head. The internal threading can also be used to fasten a cable lug by means of a threaded bolt.

If the outer contour of the first shaft part is adapted to the inner contour of the first electrically insulating part, then it is possible to achieve an unambiguous association or positioning of the bolt in relation to the first insulating part. If the outer contour of the first shaft part is adapted to the inner contour of the conductor part, then by means of the first shaft part, the conductor part can be positioned unambiguously in relation to the retainer by means of the first insulating part. This assures that the conductor part does not come into contact with a possibly ground-carrying component, and thus prevents a short circuit from occurring.

An internal threading in the first shaft part can alternatively be used to attach a cable lug.

If the conductor part has at least one connecting tab to which at least one conductor element, for example a stranded conductor, can be fastened, then the free, unsupported length of the stranded conductor between the sliding contact and the conductor part is particularly short. This has the advantage that on the one hand, it is easier to maneuver the stranded conductors when the conductor element is being welded in place since the stranded conductors are thus stiffer and do not change positions under their own weight. On the other hand, the short structural length of the stranded conductors reduces the influence of vibrations that might possibly destroy the stranded conductors.

According to another exemplary embodiment of the invention, a locking element is formed in one piece onto the conductor part and engages with a bracket of a cover that at least partially closes the electric machine. The engagement of this locking element with a bracket results in the fact that is secured in its position on the one hand through the fastening of the connecting device to the retainer or the starter motor housing, and on the other hand, is also sealed through the final fastening of the connecting element by means of a bolt. The starter motor can only be opened by damaging the seal (bolt). Furthermore, the locking element and the bracket assure that none of the parts of the starter motor can get lost during the manufacturing process of an electric machine or starter device. It is thus unnecessary to figure on a loss of parts during the manufacturing process or complicated subsequent work. If the locking element is formed in one piece onto the conductor part, then this has the advantage that the required bending of the locking element can occur at the same time as other processing steps involving the conductor part.

If the locking element is formed in one piece onto the second insulating part, then this has the advantage that when a second insulating part is embodied as an injection-molded part, the locking element can be formed onto it in the same work cycle, without requiring an additional work step.

### DRAWINGS

Exemplary embodiments of a connecting device according to the invention are shown in the drawings.

FIG. 1 shows a sectional view of a first exemplary embodiment of a connecting device,

FIG. 2a shows a view of a first electrically insulating part,

FIG. 2b shows a top view of a retainer, with a non-circular opening,

FIG. 3a shows a second exemplary embodiment of the first electrically insulating part,

FIG. 3b shows a top view of a corresponding opening in the retainer,

FIG. 4 shows a conductor part with a second electrically insulating part,

FIG. 5a shows the parts of the connecting device disposed on the outside of the retainer,

FIG. 5b shows a second exemplary embodiment of the connecting device,

FIG. 6 shows a second exemplary embodiment of the conductor part,

FIGS. 7a and 7b show two different possible embodiments for the engagement of a locking element in a bracket of a cover,

FIG. 8 symbolically depicts an electric machine with a connecting device according to the invention, and

FIG. 9 shows a starter device for internal combustion engines, with an electric machine that has a connecting device according to the invention.

### DESCRIPTION

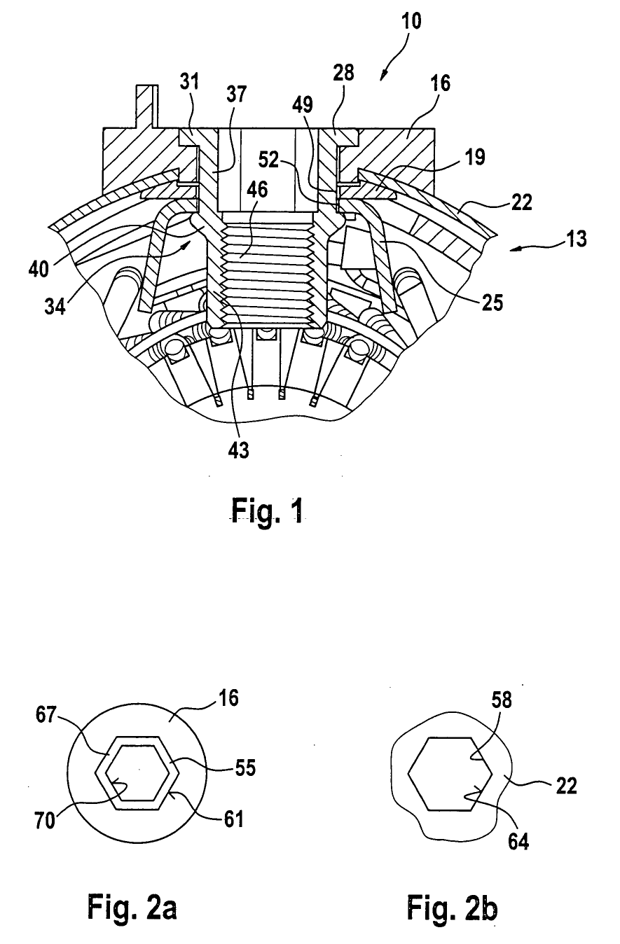

FIG. 1 shows a first exemplary embodiment of a connecting device 10 for contacting electric machines 13. The connecting device 10 has a first electrically insulating part 16, referred to below as the first insulating part, and a second electrically insulating part 19, referred to below as the second insulating part. A retainer 22 is held between the two insulating parts 16 and 19. The second insulating part 19 is adjoined by a conductor part 25 that is attached to it. The first insulating part 16, the retainer 22, the second insulating part 19, and the conductor part 25 are non-detachably connected to one another. This connection is non-detachable in that at least one of the components must be destroyed in order to break the cohesion of the connection. In the example, the above-mentioned components are connected to one another by means of a bolt 28. The fact that the retainer 22 is clamped between the first insulating part 16 and the second insulating part 19 assures a good seating of the connecting device 10 on the retainer 22. In addition, the conductor part 25 is secured to the second insulating part 19 by means of the non-detachable bolt 28. This produces a non-detachable bolt unit 29.

The bolt 28 has a bolt head 31, which is adjoined by a multipart shaft 34. The shaft 34 has a first shaft part 37, which extends through the first insulating part 16, the retainer 22, the second insulating part 19, and the conductor part 25. The first shaft part 37 is adjoined by a second shaft part 40, which is shaped into an annular bolt head. The bolt head 31 and the shaft part 40 that is formed onto the annular bolt head serve to connect the first insulating part 16, the retainer 22, the second insulating part 19, and the conductor part 25.

In the example shown, the second shaft part 40 is adjoined by a third shaft part 43 that can be used to introduce a shaping force. The third shaft part 43 is tubular in the example and has an internal threading 46. The bolt 28 shares with the first shaft part 37 a common shaft part whose outer contour 49 is adapted to an inner contour 51 of the conductor part 25.

FIG. 2a shows a view of the first insulating part 16. The drawing shows the side of the first insulating part 16 oriented toward the retainer 22. The annular and simultaneously hexagonal contour shown in the drawing is a positive engagement element 55 oriented toward the retainer 22. This positive engagement element 55 serves to engage in a counterpart positive engagement element 58 of the retainer 22. When installed, the outer contour 61 of the positive engagement element 55 adjoins the inner contour 64 of the counterpart positive engagement element 58.

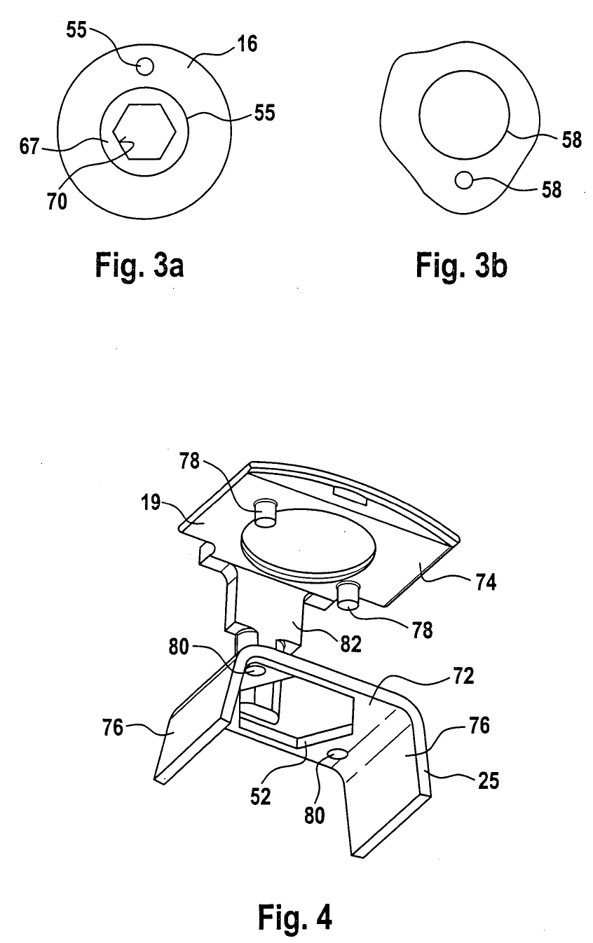

FIGS. 3a and 3b show another exemplary embodiment of such a unit comprised of the first insulating part 16 and a retainer 22. In this exemplary embodiment, the two positive engagement elements 55 on the first insulating part engage in corresponding counterpart positive engagement elements 58 on the retainer 22. In both of the exemplary embodiments, one of the positive engagement elements 55 has a ring 67, which is formed in one piece onto it, is oriented toward the second insulating part 19, and has a non-circular annular inner contour 70. The counterpart positive engagement elements 58 are respectively comprised of recesses in the retainer 22.

FIG. 4 shows the conductor part 25 on the one hand and the second insulating part 19 on the other. In the example, the conductor part 25 has a base plate 72, which in the installed position—see FIG. 1—rests against an underside 74 of the second insulating part 19. A connecting tab 76 extends from each side of the base plate 72 and these tabs are used to fasten stranded conductors that are connected to brushes of the electric machine 13, also see FIG. 1. If there is enough space, then at least one connecting tab 76 is required in order to fasten a conductor element to it. As has been mentioned previously, the conductor part 25 has a non-circular inner contour 52, which essentially corresponds to the outer contour 49 of the bolt 28.

In order to be able to mount the conductor part 25 onto the second insulating part 19 ahead of time, at least one positive engagement element 78 is formed-on, oriented away from the first insulating part 16. In order to assure a reliably positioned placement on the conductor part 25, this positive engagement element 78 is adapted to an opening 80 of the conductor part 25 that corresponds to the positive engagement element 78. The positive engagement elements 78 can be embodied, for example, in the form of pins. In addition, a locking element 82 is formed in one piece onto the second insulating part 19. This locking element 82 serves to engage in a bracket, not shown in FIG. 4, of a cover that at least partially closes the electric machine 13.

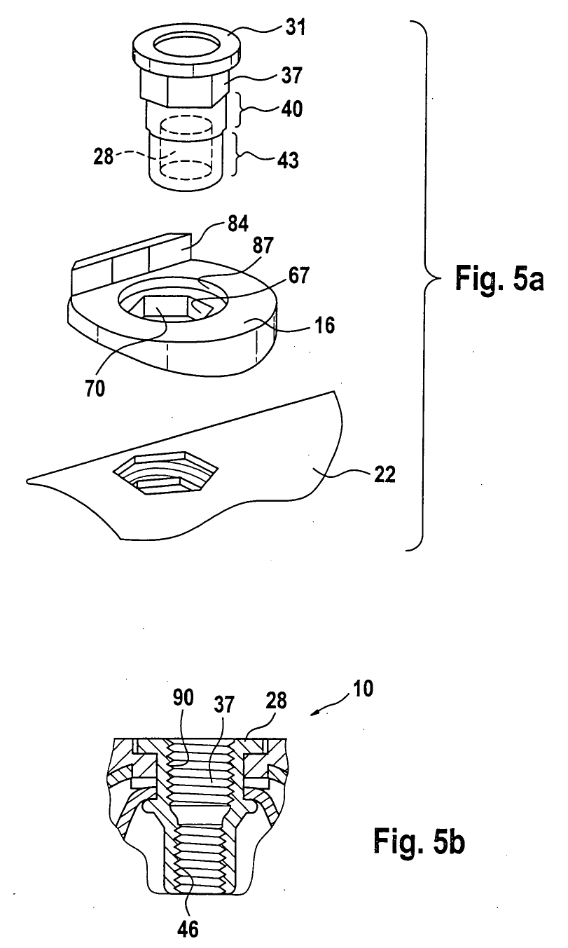

FIG. 5a shows the externally visible parts of the connecting device 10, before their installation. On the one hand, the bolt 28, the first insulating part 16, and the retainer 22 are shown. The bolt head 31, the first shaft part 37, the adjoining second shaft part 40, and the third shaft part 43 of the bolt 28 are very clearly shown. In the example, the first shaft part 37 is embodied as hexagonal. The first insulating part 16 has an abutting piece 84, which allows the cable lug of a connecting cable to be mounted in a particular position. In the vicinity of a central opening, the first insulating part has a countersink 87, into which the bolt head 31 fits. The countersink is adjoined by the ring 67, which has already been discussed in conjunction with FIG. 2a, which has the annular inner contour 70. The first shaft part 37 and the outer contour 49 of the bolt 28 are adapted to the annular inner contour 70 of the first electrically insulating part 16.

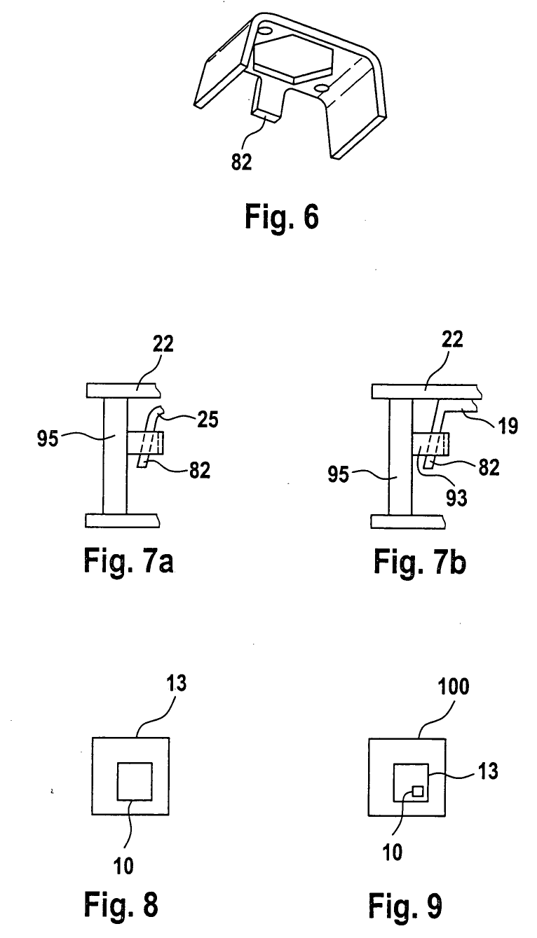

FIG. 5b shows a second exemplary embodiment of the connecting device 10. The discussion below will concentrate only on the differences in the bolt 28. By contrast with the exemplary embodiment according to FIG. 5a, in which the inside of the first shaft part 37 is embodied in a cylindrical form, and by contrast with the first shaft part 37 from FIG. 1, in which the inside is embodied in a hexagonal form, the bolt 28 in FIG. 5b has an internal threading 90 on the inside of the first shaft part 37. The internal threading 90 permits a threaded bolt to be screwed in, thus permitting a cable lug of the connecting cable to be attached and electrically contacted. In the same way, this is alternatively also possible with the internal threading 46 in the third shaft part 43 according to the exemplary embodiment in FIG. 1.

Whereas in the exemplary embodiment according to FIG. 4, the second insulating part 19 has the locking element 82 formed onto it, the conductor part 25 shown in FIG. 6 has the locking element 82 instead. As has been explained above in conjunction with FIG. 4, this locking element 82 also serves to engage with a bracket of a cover that at least partially closes the electric machine 13.

FIG. 7a shows how a locking element 82 that is formed in one piece onto the conductor part 25 engages with the bracket 93 of the cover 95. The locking element 82 that is connected in one piece to the second insulating part 19 engages with the bracket 93 in an analogous fashion.

FIG. 8 symbolically depicts the electric machine 13, which has a connecting device 10 for electric conductors.

In a likewise symbolic depiction, FIG. 9 shows a starter device 100, which has an electric machine 13 as a drive unit, which in turn has a connecting device 10.

The first shaft part 37 can alternatively also have an outer contour 49 that has the general shape, for example, of a polygon or has wavy sides. One suitable non-detachable bolt unit 29 has a rivet as the non-detachable bolt 28.

The shaft 34 has at least two parts and includes at least the first shaft part 37 and the shaft part 40 that is shaped to form the bolt head 31.

According to one variant, the retainer 22 is embodied as a pole housing of an electric machine. In another variant, instead of being embodied as a pole housing, the retainer 22 is embodied as a universal electric machine housing, which houses the electric machine. On the whole, the invention proposes using the connecting device 10 in a starter device 100. In this instance, the cover 95 is a brush holder.

1. A connecting device for contacting electric machines (13), having a first electrically insulating part (16) and a second electrically insulating part (19), wherein a retainer (22) is held between the two insulating parts (16) and (19), having a conductor part (25) that is separate from the retainer (22) and is connected to the second insulating part (19), characterized in that the first electrically insulating part (16), the retainer (22), the second electrically insulating part (19), and the conductor part (25) are non-detachably connected to one another.

2. The connecting device according to claim 1, characterized in that the first electrically insulating part (16) has at least one positive engagement element (55) that is oriented toward the retainer (22) and engages with at least one counterpart positive engagement element (58) of the retainer (22).

3. The connecting device according to claim 1 or 2, characterized in that the first electrically insulating part (16) has a ring (67) that is formed onto it in one piece, oriented toward the second insulating part (19), and has a non-circular annular inner contour (70).

4. The connecting device according to one of the preceding claims, characterized in that the conductor part (25) has a non-circular inner contour (52).

5. The connecting device according to one of the preceding claims, characterized in that the second electrically insulating part (19) has at least one positive engagement element (78) that is oriented away from the first insulating part (16) and adapted to produce a reliably positioned contact with an opening (80) of the conductor part (25), which opening corresponds to the positive engagement element (87).

6. The connecting device according to one of the preceding claims, characterized in that a non-detachable connection is produced by means of a bolt unit (29), which has a bolt (28) with an at least two-part shaft (34) adjoining a bolt head (31), wherein a first shaft part (37) extends through the first insulating part (16), the retainer (22), the second insulating part (19), and the conductor part (25), and a second shaft part (40), which can be shaped into an annular bolt head, serves to connect the first insulating part (16), the retainer (22), the second insulating part (19), and the conductor part (25).

7. The connecting device according to claim 6, characterized in that adjoining the second shaft part (40) that can be shaped to form the annular bolt head, the bolt (28) has a third shaft part (43) that can be used to introduce a shaping force.

8. The connecting device according to claim 7, characterized in that the third shaft part (43) is tubular and has an internal threading (46).

9. The connecting device according to one of claims 6 to 8, characterized in that the outer contour (49) of the first shaft part (37) is adapted to the annular inner contour (70) of the first electrically insulating part (16).

10. The connecting device according to one of claims 6 to 9, characterized in that the bolt has a shaft part whose outer contour (49) is adapted to the inner contour (52) of the conductor part (25).

11. The connecting device according to one of claims 6 to 10, characterized in that the first shaft part (37) has an internal threading.

12. The connecting device according to one of the preceding claims, characterized in that the conductor part (25) has at least one connecting tab (76) to which a conductor element can be fastened.

13. The connecting device according to one of the preceding claims, characterized in that a locking element (82) is formed in one piece onto the conductor part (25) and engages with a bracket (93) of a cover (95), which at least partially closes the electric machine (13).

14. The connecting device according to one of claims 1 to 12, characterized in that a locking element (82) is formed in one piece onto the second insulating part (19) and engages with a bracket (93) of a cover (95), which at least partially closes the electric machine (13).

15. An electric machine, in particular a starter motor, with a connecting device (10) for electric conductors, characterized in that the connecting device (10) is embodied according to the features of one of the preceding claims.

16. A starter device for internal combustion engines, wherein the starter device has an electric machine (13) as a drive unit, characterized in that the electric machine (13) is embodied according to the features of claim 15.
